(19) United States
(12) Patent Application Publication
(10) Pub. No.: US 2007/0054257 A1
(43) Pub. Date: Mar. 8, 2007

(54) Singtronics AV Box

(75) Inventor: Florentino Cruz Apeles, los angeles, CA (US)

Correspondence Address: SINGTRONICS, 3071 S. ROBERTSON BLVD., LOS ANGELES, CA, 90034, US

(73) Assignee: Mr. Florentino Cruz Apeles, Los Angeles, CA (US)

(21) Appl. No.: 11/162,373

(22) Filed: Sep. 8, 2005

(51) Int. Cl. G09B 5/00

(52) U.S. Cl. 434/307 A

(57) ABSTRACT

This is a portable. Compact. Lightweight self-contained amplifier Audio-Video Stereo System with a full Karaoke features & song recorder. The unit contains in itself a multi-player DVD player, satellite speakers, sub-woofer, main microphone and wireless microphone enclosed in a carry-all polyurethane casing. Figure Descriptions/ Legend A Satellite Speaker B Multi-Disk Player C Main Microphone D Volume Control Knobs E Power Switch F Audio/Video Input G Audio/Video Output H Wireless Sub-Microphone I Subwoofer

A portable, compact, lightweight (19 lbs), self-contained amplified (30 W) Audio-Video System with rich, deep room filling stereo sound, mike with full karaoke digital features (echo, key, tempo control) built-in 790/2,000 songs, 3,200 English song capacity, up to 7,000 song capacity with other languages, digital song recorder, RCA AV IN/OUT, a 10.2″ LCD color monitor, USB port, SD memory card reader, carrying strap ready, detachable satellite speakers, & plays movie & karaoke DVDs & VCDs, music CDs, karaoke CDGs, VCDs, MP3s including Rs & RWs (copies), cordless mike options includes AM/FM & tuner, 5 hr rechargeable battery, carrying case. etc.

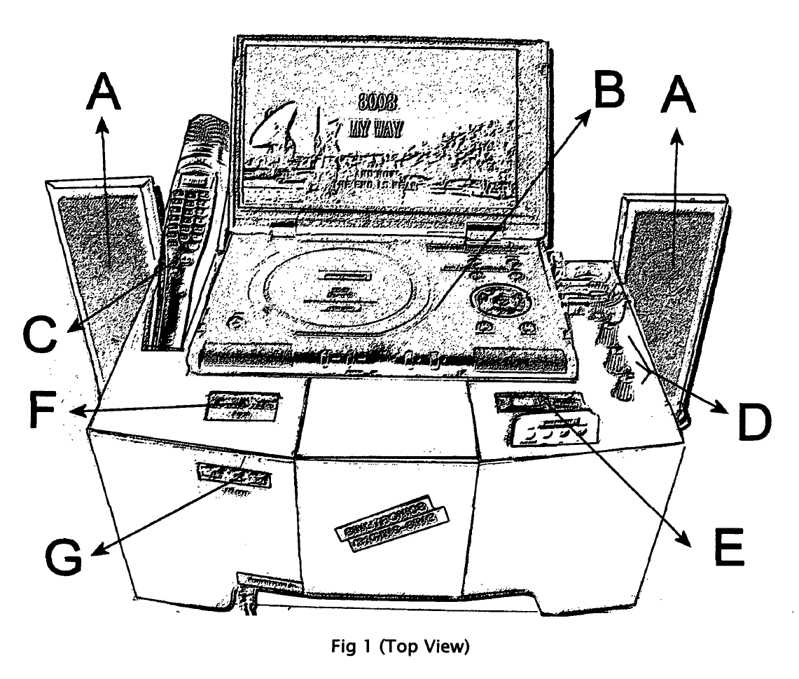

The whole system can be visualized using the Top View drawing as depicted in FIG. 1. This figure shows the microphone used in selecting the songs that needs to be cued for singing. The multi-player DVD player is utilized in showing/displaying the lyrics of the song being played and can also be used in playing desired songs from a separate CD, DVD, VCD or MP3's. This figure also shows the system options for audio/video input where the user can plug external audio/video players into the system. Then an additional outlet for audio/video output is also provided for the convenience of the user to connect to an external or additional audio/video system. terminals for plug additional systems following are the different drawing descriptions depicting the different attachment figures.

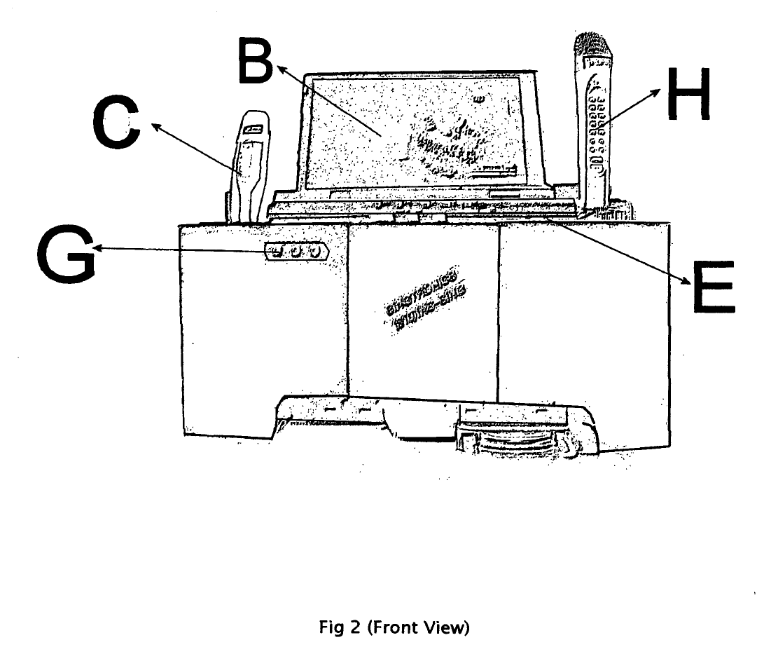

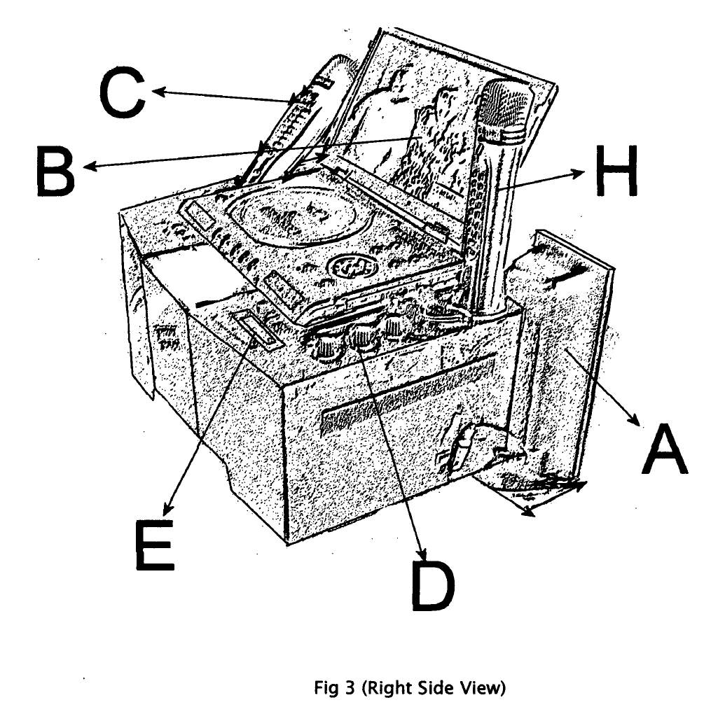

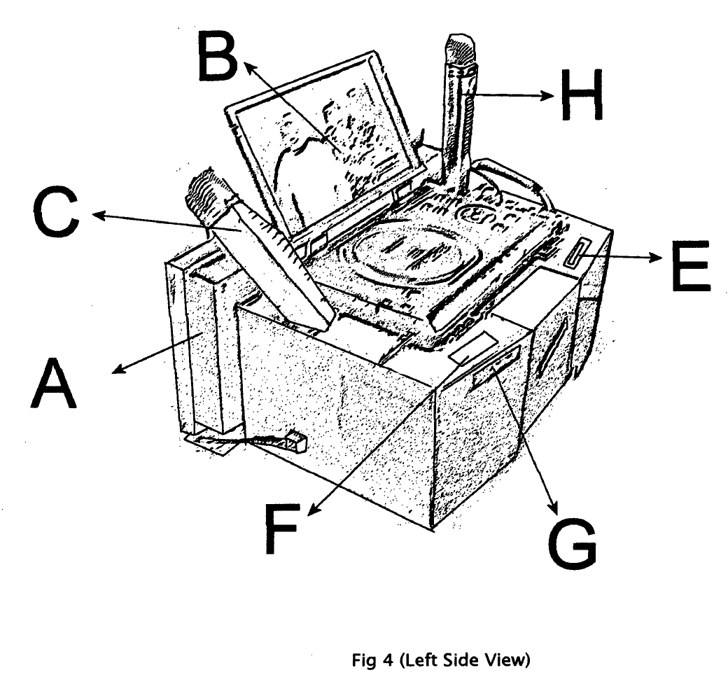

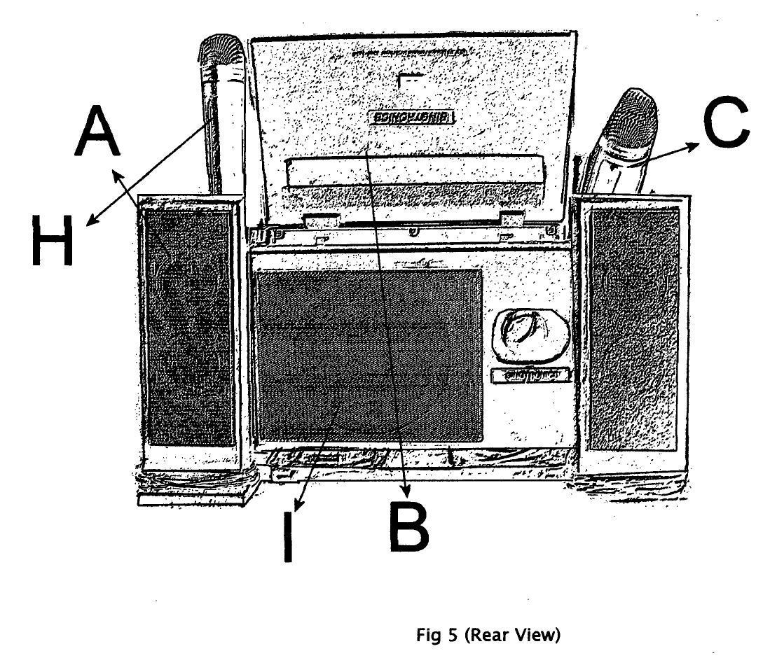

In FIG. 2, this is the front view, where one can visualize where the audio/video output plugs are located for additional or connection to an additional sound system. FIG. 3 is showing the right side view of the equipment and it is showing the other terminal where to connect the speaker and a view showing the positioning of the volume controls. In FIG. 4, which the left side view of the equipment, it shows where the other speaker terminal is located plus a view on how the other components are installed. The rear view which is shown as FIG. 5, shows the sub-woofer plus the speaker systems used plus the placement of the main microphone and the sub microphone.

What is claimed is:

1. A portable, compact, lightweight (19 lbs), self-contained amplified (30 W) Audio-Video Stereo System with full Karaoke features & song recorder, built-in songs, a 10.2″ LCD color monitor, USB port, memory card reader, detachable satellite speakers, and plays movie & karaoke DVDs & VCDs, music CDs, karaoke CDGs, VCDs, MP3s including Rs & RWs (copies), all in one unit.
